(19) United States
(12) Patent Application Publication
(10) Pub. No.: US 2004/0188201 A1
(43) Pub. Date: Sep. 30, 2004

(54) Wheel structure for travelling bag

(76) Inventor: Hsiu-Jung Chuo, Tai Chung Hsien (TW)

Correspondence Address: Leong C. Lei, PMB#1008, 1867 Ygnacio Valley Rd., Walnut Creek, CA, 94598-3214, US

(21) Appl. No.: 10/394,234

(22) Filed: Mar. 24, 2003

(51) Int. Cl. B62B 3/00; B62B 11/00

(52) U.S. Cl. 190/18 A; 280/47.371; 280/47.315; 280/655

(57) ABSTRACT

A wheel structure for traveling bag is constructed to include a wheel mount for fastening to one bottom corner of a bag, a castor fastened pivotally with the bottom wall of the wheel mount, a transverse track fixedly provided at one side of the wheel mount, a wheel holder plate detachably inserted into the transverse track, a supplementary wheel fastened pivotally with the wheel holder plate, and a retaining plate extended from the transverse track adapted to lock the wheel holder plate in the transverse track.

### BACKGROUND OF THE INVENTION

1. Field of the Invention

The present invention relates to wheels and, more specifically, to a wheel structure for traveling bag, which comprises a wheel mount holding a castor at the bottom side of the traveling bag, and a wheel holder plate detachably fastened to one side wall of the wheel mount and holding a supplementary wheel.

2. Description of the Related Art

A conventional wheeled traveling bag generally comprises a bag equipped with a retractable handle, two or four wheel mounts fixedly and symmetrically fastened to the bottom panel of the bag at two sides of the retractable handle. Each wheel mount holds a castor. By means of the castors at the wheel mounts, the traveling bag can be pulled or pushed on the floor. This design of wheeled traveling bag is still not satisfactory in function. Because the castors are vertically located on the bottom side of the bag, the user takes much effort to push or pull the wheeled traveling bag in a tilted position. Further, because the wheeled traveling bag has no directional means to control the moving direction, the user does much effort to control the moving direction of the wheeled traveling bag and, the castors are forced to change the direction irregularly at a high frequency during moving of the wheeled traveling bag. In order to eliminate these drawbacks, wheeled traveling bags with additional supplementary wheels are developed. However, these wheeled traveling bags with additional supplementary wheels occupy much storage space during their delivery from the factory to the distributors because the supplementary wheels protrude over the periphery of the bag body at a distance and are not detachable. Further, during delivery of a wheeled traveling bag with supplementary wheels, the protruded supplementary wheels tend to be damaged by an external object.

Therefore, it is desirable to have a wheel structure for traveling bag, which eliminates the aforesaid drawbacks.

### SUMMARY OF THE INVENTION

The present invention relates to a wheel structure for traveling bag, which comprises a wheel mount holding a castor at the bottom side of the traveling bag, and a wheel holder plate detachably fastened to one side wall of the wheel mount and holding a supplementary wheel.

The present invention has been accomplished under the circumstances in view. It is one object of the present invention to provide a wheel structure for traveling bag, which enables the traveling bag to be moved stably with less effort. It is another object of the present invention to provide a wheel structure for traveling bag, which enables the user to control the moving direction of the traveling bag easily with less effort. It is still another object of the present invention to provide a wheel structure for traveling bag, which is detachable. To achieve these and other objects of the present invention, the wheel structure comprises a wheel mount for fastening to one bottom corner of a bag, a castor fastened pivotally with the wheel mount at a bottom side, a transverse track fixedly provided at one side of the wheel mount, a wheel holder plate detachably inserted into the transverse track, a supplementary wheel fastened pivotally with the wheel holder plate, and lock means adapted to lock the wheel holder plate in the transverse track.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the preferred embodiment of the present invention.

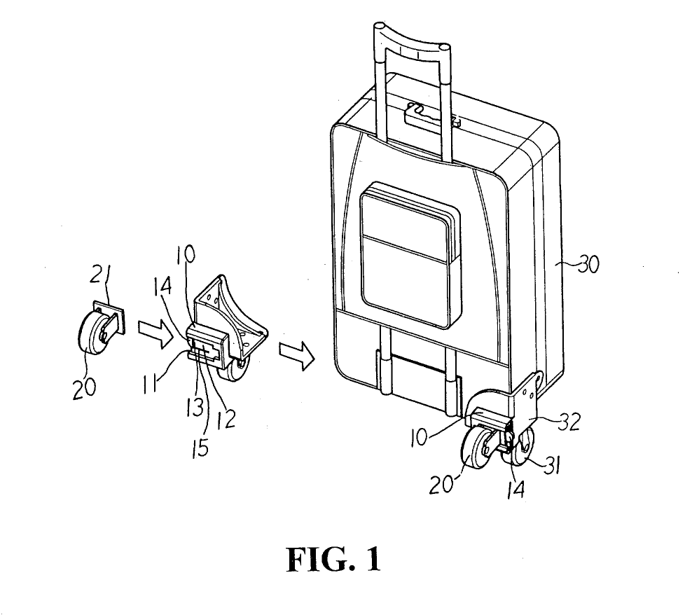

FIG. 2 is an assembly view of FIG. 1.

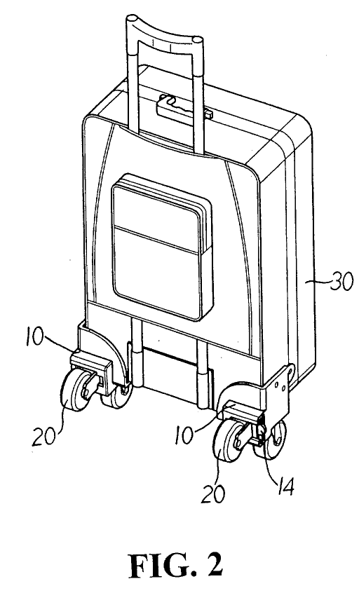

FIG. 3A and 3B are schematic views showing the procedure of the installation of the auxiliary wheel assembly in the transverse track at the wheel amount according to the present invention.

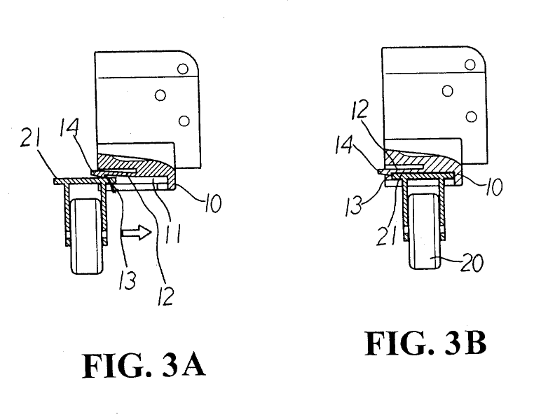

FIG. 4 is a schematic drawing showing an application of the present invention.

FIG. 5 illustrates a second preferred embodiment of the present invention.

FIG. 6 is an exploded view of the second preferred embodiment.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to FIGS. 14, a wheel mount 32 of angled hollow frame is fixedly fastened to one bottom corner of a traveling bag 30 to hold a castor 31. The castor 31 is fastened pivotally with the bottom wall of the wheel mount 32. The wheel mount 32 has a transverse track 10 horizontally provided at one sidewall and adapted to hold a wheel holder plate 21. The wheel holder plate 21 holds a supplementary wheel 20. The supplementary wheel 20 can be a directional wheel fastened pivotally with the wheel holder plate 21. The transverse track 10 has a substantially U-shaped profile, defining a sliding groove 11. A retaining plate 12 is fixedly fastened to the sliding groove 11 in the transverse track 10. The retaining plate 12 has a stepped springy retaining portion 13 extended out of the transverse track 10 and terminating in a finger strip 14. Further, a split 15 is formed in the retaining plate 12, enhancing the springy power of the stepped springy retaining portion 13. When pulling the finger strip 14 with the hand in one direction, the wheel holder plate 21 can then be inserted into the sliding groove 11 in the transverse track 10. When released the hand from the finger strip 14 after insertion of the wheel holder plate 21, the stepped springy retaining portion 13 engages a part of the wheel holder plate 21, and therefore the wheel holder plate 21 is locked. Further, the transverse track 10 has a relatively thicker upper side and a relatively thinner lower side so as to hold the supplementary wheel 20 is tilted position, i.e., the angle between the castor 31 and the supplementary wheel 20 is smaller than 90°. The transverse track 10 can be formed integral with the wheel mount 32. Alternatively, the transverse track 10 can be separately made, and then fixedly fastened to the wheel mount 32. Because the supplementary wheel assembly (the assembly of the wheel holder plate 21 and the supplementary wheel 20) is detachable, the user can install the supplementary wheel assembly in the transverse track 10 when desired.

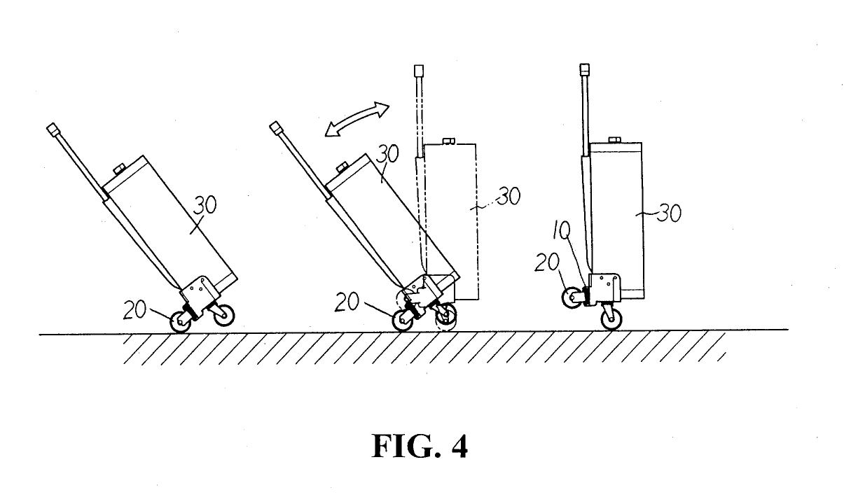

FIG. 4 shows an application example of the present invention. As illustrated, the supplementary wheel 20 supports the moving of the traveling bag 30 on the floor stably in a tilted angle, and the user can move the traveling bag 30 on the floor with less effort.

A prototype of wheel structure for traveling bag has been constructed with the features of the annexed drawings of FIGS. 14. The wheel structure for traveling bag functions smoothly to provide all of the features discussed earlier.

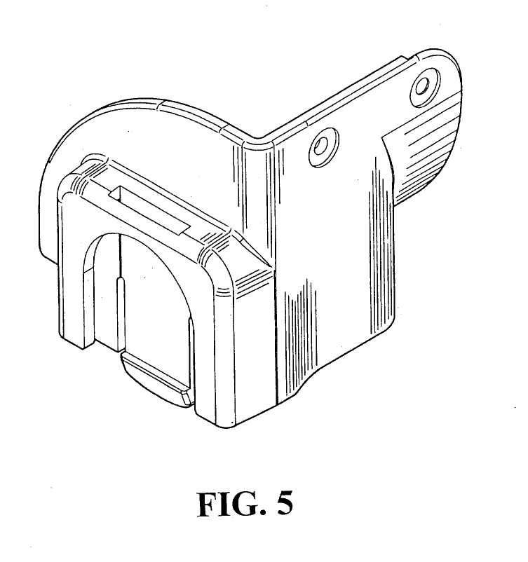

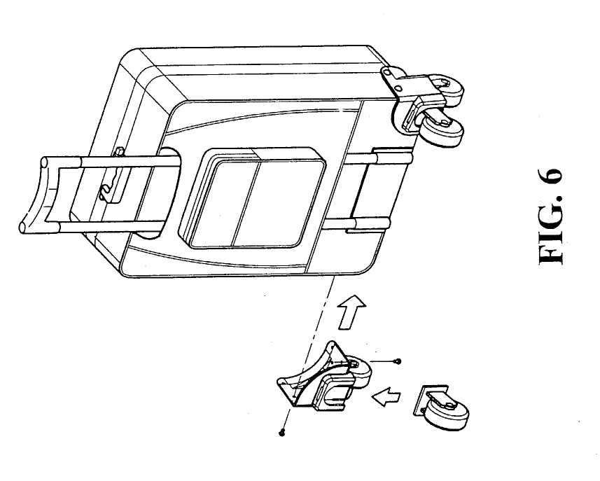

FIGS. 5 and 6 illustrates a second preferred embodiment of the present invention, wherein the supplementary wheel is fitted in a vertical track It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wheel structure for traveling bag of the type comprising a wheel mount for fastening to one bottom corner of a bag, and a castor fastened pivotally with said wheel mount at a bottom side, the wheel structure further comprising a transverse track fixedly provided at one side of said wheel mount, a wheel holder plate detachably inserted into said transverse track, a supplementary wheel fastened pivotally with said wheel holder plate, and lock means adapted to lock said wheel holder plate in said transverse track.

2. The wheel structure as claimed in claim 1, wherein said track is an independent member separately made and then fixedly fastened to one sidewall of said wheel mount.

3. The wheel structure as claimed in claim 1, wherein said lock means comprises a retaining plate fixedly fastened to said transverse track, said retaining plate having a stepped springy retaining portion extended out of said transverse track and adapted to engage said wheel holder plate after insertion of said wheel holder plate in said transverse track, and a finger strip extended from said stepped springy retaining portion for pulling by hand to disengage said stepped springy retaining portion from said wheel holder plate.

4. The wheel structure as claimed in claim 1, wherein said supplementary wheel is a directional wheel.

5. The wheel structure as claimed in claim 1, wherein said transverse track has a thicker upper side and thinner lower side for holding said wheel holder plate is a titled position.
